(19) United States
(12) Patent Application Publication
(10) Pub. No.: US 2022/0012157 A1
(43) Pub. Date: Jan. 13, 2022

(54) OPERATIONAL CHARACTERISTICS ACQUISITION DEVICE, OPERATIONAL CHARACTERISTICS ACQUISITION METHOD, AND STORAGE MEDIUM

(71) Applicant: KONICA MINOLTA, INC., Tokyo (JP)

(72) Inventor: Harsh ANKUR, Tokyo (JP)

(73) Assignee: KONICA MINOLTA, INC., Tokyo (JP)

(21) Appl. No.: 17/372,384

(22) Filed: Jul. 9, 2021

(30) Foreign Application Priority Data
Jul. 10, 2020 (JP) 2020-118848

(51) Int. Cl. G06F 11/34; G06F 3/12; H04N 1/00

(52) U.S. Cl. CPC G06F 11/3476; G06F 3/1273; H04N 1/00413; G06F 11/3438; G06F 3/1258; G06F 3/1204

(57) ABSTRACT

Provided is an operational characteristics acquisition device including an acquirer that acquires an operation log of an image forming apparatus, and an analyzer that analyzes the acquired operation log so as to generate operational characteristics data concerning appearance of an inefficient operation.

### CROSS-REFERENCE TO RELATED APPLICATIONS

The entire disclosure of Japanese Patent Application No. 2020-118848 filed on Jul. 10, 2020 is incorporated herein by reference in its entirety.

### BACKGROUND

### Technological Field

The present invention relates to an operational characteristics acquisition device, an operational characteristics acquisition method, and a storage medium.

### Description of the Related Art

In recent years, improvements have been made in techniques for statisticizing and predicting behaviors of a subject based on the activity history of the subject. JP2011081431A discloses a technique in which user behavior patterns are estimated based on measurement results of the user's motion sensor and current positions detected.

Further, it is possible to acquire a history of durations and descriptions of user input operations in devices tint operate in response to user input operations.

### SUMMARY

However, it is not easy for daily business users of image forming apparatuses to acquire information for improvements concerning errors or inefficiencies in business just by acquiring an operation history.

An object of the present invention is to provide an operational characteristics acquisition device, an operational characteristics acquisition method, and a storage medium.

To achieve at least one of the abovementioned objects, an operational characteristics acquisition device reflecting one aspect of the present invention includes:

an acquirer that acquires an operation log of an image forming apparatus; and

an analyzer that analyzes the acquired operation log so as to generate operational characteristics data concerning appearance of an inefficient operation.

To achieve at least one of the abovementioned objects, an operational characteristics acquisition method reflecting another aspect of the present invention includes:

acquiring an operation log of an image forming apparatus; and

analyzing the acquired operation log so as to generate an operational characteristics data concerning appearance of a predetermined inefficient operation.

To achieve at least one of the abovementioned objects, a storage medium reflecting another aspect of the present invention stores a program that causes a computer to perform:

acquisition of an operation log of an image forming apparatus; and

analysis of the acquired operation log so as to generate an operational characteristics data concerning appearance of a predetermined inefficient operation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram showing functional configuration of a server device and an image forming apparatus;

FIG. 2 is an exemplary operation history corresponding to input operations detected by an operation receiver;

FIG. 3 is a table showing examples of contents of specific operation pattern data;

FIG. 4 is a flowchart showing control steps of an operation log analysis process; and

FIG. 5 is a chart showing an exemplary display of output data.

### DETAILED DESCRIPTION OF THE EMBODIMENTS

Hereinafter, one or more embodiments of the present invention will be described with reference to the drawings.

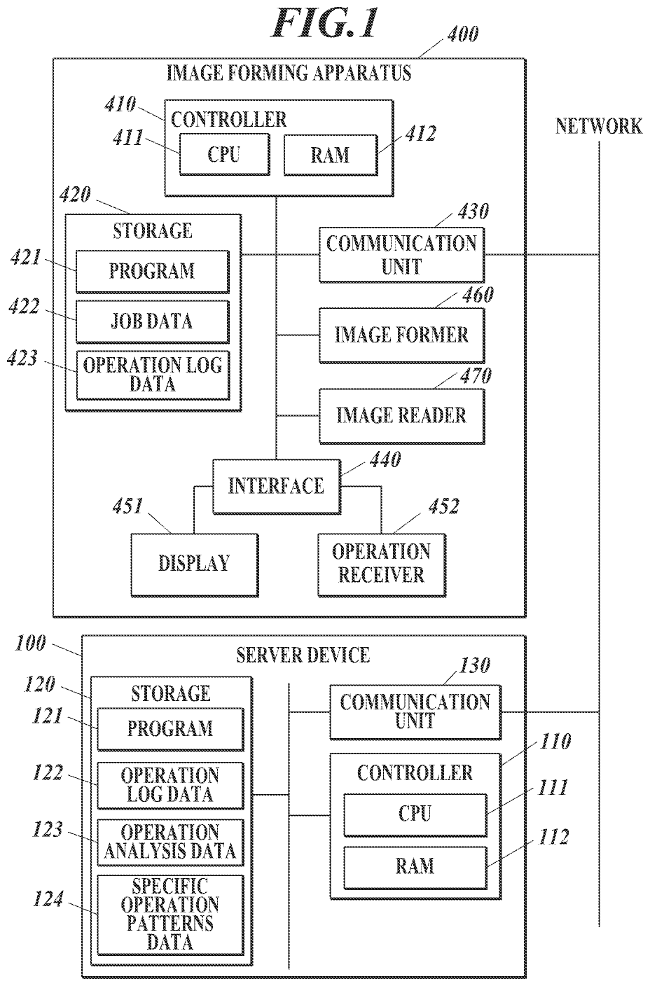

FIG. 1 is a block diagram showing a server device 100, which is an operational characteristics acquisition device of the present invention, and an image forming apparatus 400.

The server device 100 retrieves and analyzes operation log data from the image forming apparatus 400, and outputs analysts results. The server device 100 may be a normal computer (PC). The server device 100 includes a controller 110 (analyzer), a storage 120, and a communication unit 130.

The controller 110 centrally controls the overall operations of the server device 100. The controller 110 includes a central processing unit (CPU) 111 and a random access memory (RAM) 112. The CPU 111 is a hardware processor performing various kinds of arithmetic processing. The CPU 111 can read out and execute a program(s) 121. The RAM 112 provides a work memory space for the CPU 111 and stores temporary data.

The storage 120 is a non-volatile memory such as a flash memory, a hard disk drive (HDD), or the like, and stores the program 121, operation log data 122, operation analysis data 123, and specific operation pattern data 124.

The program 121 includes a program that analyzes the operation log data 122 and outputs the operation analysis data 123. The operation log data 122 is data of logs concerning actions or the image forming apparatus 400 acquired from the image forming apparatus 400. The logs of operations include details of input operations (including invalid ones) received on the operation receiver 452. The server device 100 can acquire and analyze the operation log data 122 from each of multiple image forming apparatuses 400, but in this embodiment, the operation log data 122 is handled individually in each of the image forming apparatuses 400 and not integrated.

The operation analysis data 123 is data on analysis results acquired by analysis of the operation log data 122. The operation analysis data 123 indicates characteristics of operations (mainly input operations) on the image forming apparatus 400, as described above.

The specific operation pattern data 124 is data of a list which includes examples of specific inefficient operation patterns that often appear in the operation logs. The operation patterns are respectively associated with deduced information of a cause or the like of appearance of each of the patterns. The specific operation pattern data 124 is described later in detail.

The communication unit 130 controls communication between external devices including the image forming apparatus 400. The communication unit 130 includes a network card that sends and receives data via a local area network (LAN), for example, in accordance with a predetermined communication standard. In this embodiment, the operation log data of the image forming apparatus 400 is acquired via the communication unit 130 as an acquirer.

The image forming apparatus 400 forms and outputs an image onto a medium according to output target image data. The image forming apparatus 400 includes a controller 410, a storage 420, a communication unit 430, an interface 440 (I/O) alongside with a display 451 and an operation receiver 452 connected thereto, an image former 460, and an image reader 470.

The controller 410 centrally controls the overall operations of the image forming apparatus 400. The controller 410 includes a CPU 411 and a RAM 412. The CPU 411 is a hardware processor that performs various kinds of arithmetic processing and control processing. The RAM 412 provides a work memory space for the CPU 411 and stores temporary data.

The storage 420 stores various programs 421, job data 422 concerning setting data and image formation, and the like. The programs 421 include a program for causing the image former 460 to perform image formation based on the job data 422, a program for retaining, as the operation log data 423, operations of functions and components and input operations detected by the operation receiver 452 in association with the date and time information. The programs 421 and the setting data are stored in a non-volatile memory such as a flash memory, an HDD, or the like.

The job data 422 is data on image formation orders received externally via the communication unit 430. The job data 422 includes target image data, information on various settings concerning image formation such as a direction, a size, and margins of a medium, setting of single/double sided printing, and the like. The job data 422 may be retained fora predetermined period after the image formation is completed, or may be deleted each time. If the job data 422 is deleted each time, all or part of the job data 422 may be stored in a volatile memory such as a DRAM.

The data to be transmitted to the storage 120 includes the operation log data 423. As described above, the operation log data 423 is data on logs of the actions/operations of the image forming apparatus 400 (especially operations detected by the operation receiver 452) in association with the date and time information. A file of the operation log data 423 may be generated day by day, for example.

The communication unit 430 controls communication between external devices such as the server device 100 and a print server that sends the job data. The communication unit 430 includes a network card that sends and receives data via a local area network (LAN), for example, in accordance with a predetermined communication standard.

The interface 440 includes terminals, drivers, and the like to connect peripherals. Here, the display 451 and the operating receiver 452 are connected to the interface 440. The peripherals may be connected via USB or the like, which is in accordance with a universal standard.

The display 451 includes a display screen for displaying various statuses, a selection menu, and the like under the control of the controller 410. The display 451 is, for example, a liquid crystal display, but not limited to it. The display 451 may include a light emitting diode (LED) lamp or the like to be switched on and off or blinked according to the status.

The operation receiver 452 receives input operations externally, for example, from a user, and outputs them as the input signals to the controller 410. The operation receiver 452 includes, for example, a touch panel, and is overlaid on the display screen. In addition to this, the operating receiver 452 may include various switches such as push buttons, a numeric keypad, and the like. In the image forming apparatus 400, under the control of the controller 410, a main menu is displayed on the display screen, for example, and receives orders of writing, reading, duplicating, and the like according to a selecting operation of a selection button displayed on the menu. A selection button(s) of a sub-window(s) (reception screen(s), plural in many cases) for various settings is displayed on the main menu, and a sub-window is opened in response to a selecting operation of one of the selection buttons. As reception buttons, tabs, slides, and confirmation buttons thereof concerning modification of the settings are operated on the sub-window, the settings are modified and retained.

The image former 460 applies coloring materials on a supplied medium to form an image. The image former 460 is not limited, but may be of an electrophotographic type which applies toner on a photoreceptor according to the exposure pattern thereon to be transformed and fixed onto a medium, for example.

The image reader 470 takes an image of a predetermined reading surface of a target medium and generates read image data. The image reader 470 includes a line sensor, for example, and generates two-dimensional read image data by scanning the reading surface.

Next, acquisition and analysis of the operation logs in the present invention are described.

In the image forming apparatus 400, the control actions by the controller 410 (including image formation and reading), transmission and reception of data by the communication unit 430, and detection of input operations by the operating receiver 452 are acquired in association with the date and time information and retained as the operation log data 423. In the image forming apparatus 400, the operation log data 423 may be retained for a predetermined number of days and each log is deleted after the number of days. The operation log data 423 may be regularly transmitted to the server device 100. For example, the data on the previous data may be transmitted at the start of power supply every day.

The operation logs may be associated with the elapsed time (interval) from the previous operation, not with the date and time information.

In the operation log data 423, all the operations/actions are stored including invalid input operations on the operation receiver 452. That is, all the operations detected and transmitted to the controller 410 are included, not only valid operations in response to which the image forming apparatus 400 eventually performs some kind of processing or setting by necessary operations but also invalid input operations which are mistakenly done and canceled and input operations to which no action is assigned are included.

The actions according to the input operations are stored as the operation logs, but in the case where an input operation does not involve any actions as described above, a log of an input operation in response to which no action is performed is stored with, for example, data on a type of a screen (window) being displayed and coordinates of a touched position. In the case where a setting can be switched at multiple steps, not only a confirmed setting change but also operations of switching the setting may be stored. In the case where the changed setting is confirmed, the actual “setting data change” is stored in the operation logs.

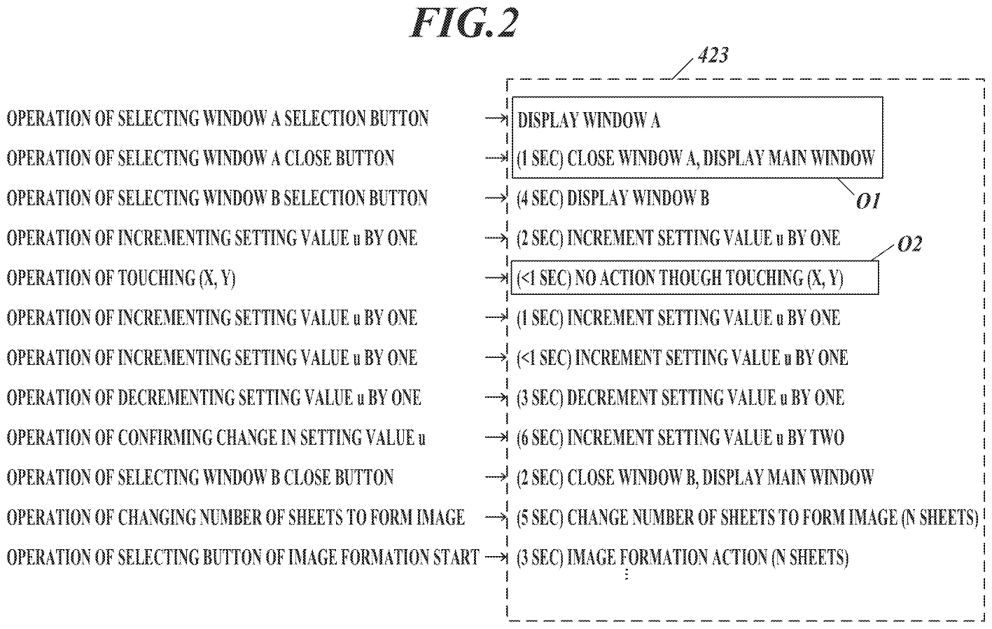

FIG. 2 shows exemplary operation logs according to input operations detected by the operation receiver 452.

The received operations are shown on the left, and the operation logs including the corresponding actions are shown on the right boxed by broken lines.

In response to a selecting operation (touch, tap, or click) of a button for selecting a window A while the main window is displayed, the window A is selected and displayed on the display 451 under the control of the controller 410. The “selection and display of the window A” is additionally stored as an operation log. Next, in response to a selecting operation of a button for closing the window A, the window A displayed on the display 451 is removed and the main window is displayed again, under the control of the controller 410. At this time, a time interval between the previous action and the present action is stored therewith. Here, one second is indicated, that is, the window A is closed within 1 second or more and less than 2 seconds. The time interval may be measured by a millisecond unit or by a value corresponding to the frequency of the system clock.

Then, in response to a selecting operation of a button for selecting a window B, the window B is displayed on the display 451. It takes 4 seconds since the window A is closed until the window B is displayed.

In response to an input operation for incrementing a setting value u by one, a log of an operation of incrementing a setting value u by one is stored as an operation log even if the operation is not confirmed. Then, in response to an operation of touching a position with coordinates (X, Y) to which no action is assigned on the display screen (window B), a log that no action is performed as a result of touching the position with the coordinates (X, Y) is stored (operation without action). Here, a log may indicate that the position with the coordinates (X, Y) is within a predetermined distance (for example, within 2 centimeters) from the range of the operation of incrementing the setting value u by one. Logs for an operation of incrementing the setting value u by one and that for decrementing the value by one are additionally stored.

In response to an input of an operation of confirming the change of the setting value u, the operation of changing the setting value u is added to the operation logs. In response to a selecting operation for closing the window B, the window B is removed and the main window is displayed again. The number of sheets to form images is set according to an operation of changing the number of sheets to form images on the main window (for example, N sheets), the image formation on N sheets is performed by the image former 460.

In the case where multiple users use the image forming apparatus 400, the logs may be stored with identification of users doing the operations based on the account information concerning each operation, or may be integrally managed without identification of users.

Among those operations, the operations surrounded by a frame O1 to display the window A and close it without doing any thing and the operation surrounded by a frame O without action are usually meaningless and useless operations. It is generally estimated that the operations in the frame O1 are categorized as an operation pattern where the user does not exactly know on which window the intended operation button exists, that is, due to lack of knowledge about the user interface (UI), or an operation pattern where the user simply performs an erroneous operation. In the case where the opened window is closed quickly without taking time to check the contents, and in the case where the correct window (the window B in this example) is then opened by the next operation, it is likely a simple erroneous operation. On contrary, operations to open and close windows other than the window B to be actually opened are sequentially done, they are likely due to lack of knowledge of the user about the UI.

The operation in the frame O2 is done simply because the user does not accurately perform the operation, or because the display range and the corresponding operation reception range are misaligned. In the latter case, multiple input operations are likely to be performed at positions shifted solely toward the specific side for each of the detection ranges of multiple operations, and in the former case, the positions are randomly deviated.

As inefficient operations increase due to user problems or device problems of the image forming apparatus 400 as described above, it is obvious that it takes time more than necessary for image formation as much. Causes of waste of time are estimated from patterns of appearance of inefficient operations in the operation logs (an operation pattern), especially orders and intervals of input operations. In the server device 100, the operation log data is acquired and analyzed, and the appearance states of inefficient operations are generated as operational characteristics data and output. Here, patterns of inefficient operations likely to appear are stored as the specific operation pattern data 124 in advance, and the appearance states of the inefficient operations are analyzed by detecting the operations corresponding to the specific operation patterns in the operation log data.

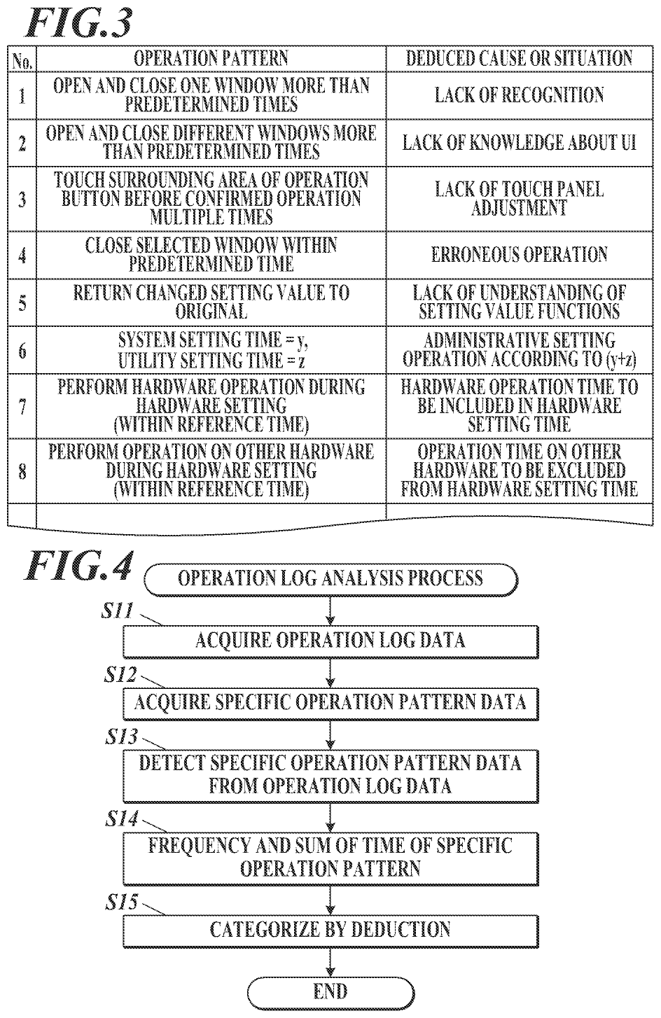

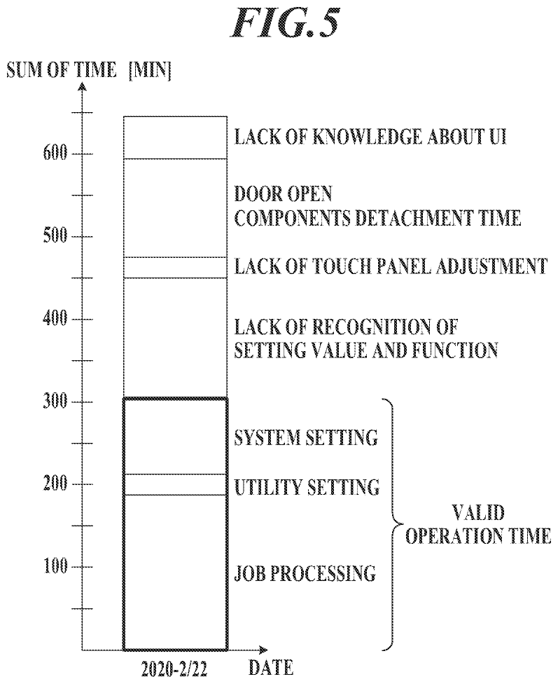

FIG. 3 is a table showing examples of contents of the specific operation pattern data 124, which is a list of inefficient operations.

For example, an operation pattern shown in the row No. 1 (the first operation pattern) is repeatedly opening and closing a window (such as a sub-window) on which the intended operation (concerning the final selection) is eventually performed. Lack of recognition of the UI is deduced from this operation pattern. It is deduced that the user generally understands or recognizes on which window the intended selecting operation is performed but does not know where the intended selection button is positioned on the window, or the user is not good at finding a desired button from buttons on a window (lack of attention, etc.). That is, the specific operation pattern data 124 includes not only the inefficient operation patterns simply but also causes or conditions of the operation patterns as deduction data.

An operation pattern shown in the row No. 2 (the second operation pattern) is opening and closing an incorrect window before the intended operation (concerning the final selection) more than a predetermined number of tunes. Lack or knowledge about the UI (concerning the operation screens) is deduced from this operation pattern. It is deduced that the user does not even know on which window the intended selecting operation is performed.

An operation pattern shown in the row No. 3 (the third operation pattern) is touching an area around the operation reception range of the selection button of the selecting operation multiple times, especially toward a specific direction (a predetermined surrounding area). Inaccurate correspondence of the operation setting range and the display range of the display screen, resulting from misalignment of the touch panel and the display screen, is deduced from this operation pattern.

An operation pattern shown in the row No. 1 (the fourth operation pattern) is closing a sub-window (a reception screen) which is opened once is closed within a predetermined time. A simple erroneous operation by the user is deduced from this operation pattern. The predetermined time is not limited but may be one second, for example. In the case where the average interval of operation inputs of each user is retained, the predetermined time may be dynamically adjusted.

An operation pattern shown in the row No. 5 (the fifth operation pattern) is changing a setting value (a predetermined setting parameter) once and returning it to the original value. It is deduced from this operation pattern that the user does not fully grasp the function of the setting value, changing it casually. It is deduced that the user lacks understanding of the functions of the setting values. The operation of decrementing the setting value after slightly excessively incrementing it is shown in the example in FIG. 2. Lack of understanding is not necessarily deduced from this operation, if the setting u is decremented by two to the original value and the confirmation operation is then performed, it fits into the operation pattern of No. 5.

In addition to the operation patterns of No. 1 to 5 due to a user's problem, characteristics of normal operations/actions that involve no problem in each operation may be statistically identified. It is made clear that the user operation beside the job processing directly related to image formation, such as how much time it takes to perform a system setting operation on the system setting screen and a utility setting operation on the utility setting screen, by statistically grasping which window is opened by the user to perform which operation as shown as an operation pattern in the row No. 6.

Here, the administrative setting operation is deduced from the simple addition sum of the system setting time y (the first time) and the utility setting time z (the second time). The administrative setting operation is not necessarily a productive operation but an indispensable operation depending on the situations. It is deduced that the administrative setting is performed more than necessary, that the productivity is low, or that the image forming apparatus 400 or its installation site is in a situation that necessitates a lot of operations related to the administrative setting. That is, the time for the administrative setting operations is used as an index of the amount of the administrative operations. The cause or situation may be deduced based on not only the simple addition sum of the system setting time y and the utility setting time z but also its ratio to the time x for processing of regular jobs. In the case where the waiting time without no input operation on each screen is above a predetermined time, the user may be away from the display screen (touch panel), and the waiting time may be omitted from the processing time or operation time. In the case where an operation pattern such as those in No. 1 to 5 appears during the administrative setting operation, the time for that is defined as that spent on the corresponding operation pattern.

In addition to the touch panel operation, there may be maintenance of the internal configuration of the image forming apparatus 400 such as replenishment of recording media, replacement of a coloring material or developer, and removal of jams. The opened state of the door of the body, and the detached state of detachable components such as a tray and a toner cartridge are detected on the image forming apparatus 400, though they are not specified by the user who performs the maintenance. Therefore, for example, as shown in the row No. 7, in the case where, during an input operation concerning a predetermined device component or consumable (component) on a touch panel, an operation of handling the component (manual operation) within a reference time is interposed, the time spent on the input operation on the touch panel and the time spent on the manual operation of handling the component may be collectively defined as the setting operation time. That is, the user can be recognized as a person who can handle the concerning hardware.

When handling a tray, a user may handle another tray supplying other recording media. The hardware that is the target of the touch panel operation and the hardware that is operated does not necessarily correspond to each other perfectly one-to-one. The time spent on direct operations of components corresponding to one related hardware may be categorized in one group.

As shown in FIG. 8, on contrary, in the case where, during an input operation concerning settings of a predetermined component on a touch panel, a manual operation of handling a different component not related to the predetermined component is performed, the manual operation or handling the different component may be treated separately (separated and excluded from the operation time on the touch panel).

The same cause or situation may be deduced from multiple operation patterns in the specific operation pattern data 124. On contrary, multiple causes or situations may be deduced from one operation pattern.

FIG. 1 is a flowchart showing control steps of the operation log analysis process by the controller 110 in the server device 100 in this embodiment. The process including the operational characteristics acquisition method in this embodiment is included in the program 121, and is started once a day at a predetermined timing, for example. The operation log data is transmitted from the image forming apparatus 400, received and stored as described above (acquisition step, acquisition method), and may be retained before the operation log analysis process.

At the start of the operation log analysis process, the controller 110 (CPU 111) selects and acquires the operation log data 122 to be the target of analysis from the storage 120 (Step S11; this step may be included in the acquisition step or the acquisition method of this embodiment). The controller 110 reads the specific operation pattern data 124 from the storage 120 (Step S12).

The controller 110 reads the operation log data 122 in order, and detects a part corresponding to a specific operation pattern (Step S13). Here, the controller 110 may also determine processing of regular jobs, utility setting, system setting, and a standby state (including during image formation). The controller 110 calculates frequency and a sum of time spent on each detected specific operation pattern (Step S14). The controller 110 may calculate a job processing time, utility setting time, system setting time, and standby time. The processing which is sequentially performed under the control of the controller 410 such as image formation (for example, actions of components controlled by the controller 410 after acquisition of an image formation order in FIG. 2) does not affect the operation efficiency Thus, such processing is not necessarily categorized in detail, and may be included in the standby time or simply excluded from the analysis target.

The controller 110 acquires the sum of time for each of deduced causes or situations and each of operation patterns to generate output data (Step S15). The controller 110 ends the operation log analysts process.

Steps S13 to S15 are included in the analysis step and the analysis method in this embodiment.

FIG. 5 is a chart showing an exemplary display of output data. The controller 110 can output the output data concerning the operational characteristics as numerical values, but may also convert the data into an image in a predetermined format and output it as data displayed by a HTML browser, a dedicated soft (application), or the like.

In FIG. 5, the sum of the operation time of a certain day is shown by operation patterns and deduced causes or situations by a columnar graph. The job processing, utility setting, and system setting on the lower side are valid actions (operations) that are performed normally. When processing of the utility setting and system setting (operation time) are longer than a reference time as described above, a cause or situation is deduced from that.

The detected time is shown by a deduced cause or situation about the operations not included in the valid operations. The operation time not necessarily a wasted time is included, such as the operation of opening the door. It is shown here that the time spent because of lack of function recognition concerning setting values is comparatively long. The time spent on the operation of opening the door or removing components is also long. Regarding the latter operations, the operations on the door or the trays may be shown further separately, and the time spent in replenishing the recording media and the frequency of troubles such as jam can be estimated therefrom. The users or administrator may visually check these outputs to grasp the problems of the current operations. If multiple causes or situations are deduced from an operation, the time spent on that operation may be shown with separate descriptions of the deduced causes and situations, or shown in the middle of the graph items of the deduced causes or situations to be understood as being included.

Such output may be acquired to be displayed not only by the image forming apparatus 400, but also by a computer (PC, etc.) connectable (having an authority to connect) to the server device 100 via a network. The administrator of the image forming apparatus 400 may acquire the output results of the respective users and learn, by comparison, problems in the user operations for feedback.

As described above, the server device 100 in this embodiment includes the acquirer (the communication unit 130, including the controller 110 in some cases) that acquires the operation logs of the image forming apparatus 400, and the controller 110 as the analyzer that analyzes the acquired operation logs so as to generate the operational characteristics data concerning the appearance of predetermined inefficient operations. As the inefficient operations are detected in the operation logs of the image forming apparatus 400 in this way, information on the inefficient operations which actually appear even though the image forming apparatus 400 apparently operates along with repeated setting operations in a normal way can be appropriately acquired so that the work efficiency is improved. It is possible to acquire points to be improved in the operations of the image forming apparatus and thereby possible to improve the work efficiency and the tike. In particular, when the operational characteristics of the image forming apparatus 400 are analyzed on the server device 100, only the operation log data is necessary. Thus, the data exchange and processing is easier.

The input operations on the image forming apparatus 400 are included in the operation logs, and the controller 110 as the analyzer determines inefficient operations based on the order and intervals of the input operations. Unlike mechanical problems, the details and extent of the inefficiency concerning the user operations in particular are different by abilities and personalities of users. Thus, it is easier to effectively improve the operation efficiency by appropriately acquiring the evaluation of the inefficient operations.

The server device 100 includes the storage 120 that stores the operation patterns of inefficient operations as the specific operation pattern data 124. The controller 110 as the analyzer detects operations that correspond to the operation patterns from the operation log data 122.

The inefficient operation patterns are usually limited to some extent. Thus, as the patterns are retained as the list data in advance and the matches are simply searched, it is possible to learn the extent and situations of appearance of the inefficient operations by a simple process on the server device 100.

The storage 120 stores the operation patterns and the causes or situations deduced from the operation patterns in association with each other in the specific operation pattern data 124. The controller 110 as the analyzer generates the operational characteristics data including the appearance or the inefficient operations and the deduced causes or situations in association with each other. That is, as the user can easily acquire the deduced causes or situations corresponding to the appearance of the inefficient operations together, it is possible to easily learn what kind of measures and efforts can be taken to improve the efficiency.

Some of the operation settings of the image forming apparatus 400 are operated on the reception screens displayed by the selecting operation of the selection buttons shown on the display screen. The operation patterns include the first operation pattern of opening and closing the reception screen more than a predetermined number of times before the operation concerning the final selection. The storage 120 stores information indicating that lack of skills in finding the object on the operation screen is deduced from the first operation pattern. When the target operation is not promptly performed and the sub-window is repeatedly opened and closed even though the target sub-window is selected in that way, the user recognizes the sub-window for the setting but does not reach the position of reception of the final operation because of oversight. This may be because the user is simply impatient and overlooks, or does not thoroughly search (for example, looking well at the beginning and end of a line but not the middle part). The resolutions to these are completely memorizing the operation positions from the start, trying to search the screen more thoroughly, or adjusting the operation screen by customization so as to make it easier for the user to search. An appropriate measure is to be taken dependent on the situations of the user or the workplace.

The operation patterns include the second operation pattern of opening and closing reception screens other than the intended reception screen more than a predetermined number of times before the operation concerning the final selection. The storage 20 stores information indicating that lack of knowledge about the operation screens is deduced from the second operation pattern. When unnecessary sub-windows are opened and closed, the user does not comprehend the meaning of categorization of the sub windows, and does not remember the position of the sub-window concerning the necessary operation by experience. It is fundamentally due to lack of understanding about the UI. Thus, as the user may select a sub-window related to the intended operation at least by memorizing the sub-windows for the necessary operations or comprehending the meanings of the sub-windows. The user then can reduce the trouble of opening unnecessary sub-windows at random.

The input operation may be received via the touch panel overlaid on the display screen. The operation patients include the third operation pattern of touching multiple times a surrounding area of the reception range of the selecting operation before the input operation on the touch panel concerning the final selection. The storage 120 stores information indicating that misalignment of the display position of the display screen and the operation reception range of the touch panel is deduced from the third operation pattern.

When an obviously unnatural touch operation is repeatedly received as described above, it is more likely that the touch panel has a problem, not the user. The problem may be solved by urging the positioning adjustment between the display on the display screen and the touch panel. It is also possible that the user has a specific problem (for example, the touch position is disoriented and shifted by an extremely rough touch). This operation may be defined as another operation pattern, and another cause or situation may be deduced according to distribution of the touch positions and a difference between users.

The operation patterns include the fourth operation pattern of performing an input operation for closing a sub-window within a predetermined time ater the sub-window is opened. The storage 120 stores information indicating that an erroneous operation of the user is deduced from the fourth operation pattern.

When a sub-window is closed without taking time to check the contents, the user immediately finds out that a window other than the originally intended sub-window is opened. That is, an incorrect sub-window is opened unintentionally and accidentally. An erroneous operation is deduced from this operation. When there are a lot of such erroneous operations, a problem may lie in the way the user performs input operations, or in the personality of the user which allows the user to perform input operations without properly checking the screen. It is possible to easily improve the operation efficiency by pointing out such a problem as a deduced cause or situation.

The operation patterns include the fifth operation pattern of changing a predetermined setting parameter from an original value and returning the setting parameter to the original. The storage 120 stores information indicating lack of understanding of the function of the setting parameter is deduced from the fifth operation pattern.

An operation of restoring completely the original setting is performed without recognizing the necessity of change in the setting value. The user lacks understanding of the functions of the setting values. Thus, as such information is shown as a deduced cause or situation, it is possible to prompt the user to more accurately understand the functions, and it is possible not only to improve the operation efficiency but also to acquire more appropriate image outputs.

The controller 110 as the analyzer calculates the first time (y) for the system setting of the image forming apparatus 400 and the second time (z) for the utility setting, and uses the first time (y) and the second time (z) as an index indicating the amount of the administrative operations. An operation which is indispensable depending on the situation and position, like the administrative operation, may result in the inefficiency depending on its extent. Thus, the output of the index may lead to improvement toward the efficient operations.

The controller 110 as the analyzer defines, in the case where the manual operation of handing a predetermined component is interposed within a reference time during the input operation concerning the component, the sum of the time of the manual operation and the time of the input operation as the operation time concerning the component. When the input operation on the touch panel and the manual operation of handling the actual component are sequential as described above, it is possible to appropriately perform the analysis process by dealing with them collectively. In particular, the operations concerning replacement and replenishment of consumables are indispensable and less specialized, and thus it is better to integrate such operations without detailed categorization to acquire more visible operational characteristics data.

On contrary, the controller 110 as the analyzer defines, in the case where a manual operation of handling a different component than the predetermined component is interposed within a reference time during the input operation concerning the predetermined component, the operation time concerning the predetermined component excluding the time spent on the manual operation of handling the different component. The manual operation of handling a component irrelevant to the input operation interposed during the input operation is dealt with as a different operation because it is meaningless to deal with different operations collectively. That is, it is possible to generate the operational characteristics data concerning inefficient operations by categorizing not only input operations but also all kinds of operations.

The operational characteristics acquisition method includes an acquiring step to acquire the operation logs of the image forming apparatus 400, an analyzing step to analyze the acquired operation logs to generate the operational characteristics data concerning the appearance of the predetermined inefficient operations. This operational characteristics acquisition method can improve the operation efficiency by appropriately learning the appearance of the efficient operations concerning the use of the image forming apparatus 400.

The program 121 may cause the computer (the controller 110) to perform the above described operational characteristics acquisition method. Thus, it is possible to acquire the characteristics of the operations of the image forming apparatus 400 without the need for a dedicated hardware. The management of the characteristics of the operations of multiple image forming apparatus 400 on an external device (computer) or the like. Thus, it is possible to reduce the cost and labor for improvement toward more efficient operations.

The present invention is not limited to the above-described embodiment, and various modifications are possible.

For example, in the above embodiment, the deduced causes or situations are shown with the operational characteristics data concerning the analysis results. However, the causes or situations are not necessarily shown because it is not very difficult to deduce them as long as the categorization is appropriate as described above.

In the above embodiment, the administrative setting operations are described as possible inefficient operations. However, the administrative setting operations may be excluded from the detection target of the inefficient operations, or, on contrary, the administrative setting operations may always be defined as inefficient operations without exception.

In the above embodiment, the manual operations of handing the components (device components and consumables) are also the targets. However, the operational characteristics data concerning the input operations may only be analyzed and acquired.

In the above embodiment, the operation patterns corresponding to those stored in the storage 120 are detected as the inefficient operation patterns, but the present invention is not limited to this example. For example, the extent of the inefficiency may be shown not only by simple match or mismatch, but also by quantitative evaluation according to the amount of match or the like. The preset operation patterns are not limited to those initially installed, but new patterns may be added thereto. The new patterns may be added by the administrator or the like, or files of updated specific operation pattern data may be regularly updated from an external dedicated server. Further, in the case where tendencies of users are detected in the process of the analysis of the operation log data 122 at a frequency more than predetermined, the detected tendencies may be presented to the administrator as possible inefficient operations.

The output screen shown in FIG. 5 in the above embodiment is an example, and the present invention is not limited to this. The output screen may simply show a table of values, or a line chart or the like of data on multiple days (changes in values). Alternatively, the output screen may show the operational characteristics of multiple users arranged to allow comparison.

The inefficient operations shown in the above embodiment are performed on the display screens, the sub-windows in particular, but the present invention is not limited to this example. The input operations may be performed via a numeric keypad, a keyboard, or the like, and in that case, the third operation pattern does not appear, but the specific operation pastern data 124 may be modified or maintained as it is. In the above embodiment, the sub-windows are described. The sub-windows are displayed in place of the main window, or displayed partially overlapping with the main window. A pull-down menu may be included so as to options are temporarily shown. In the case where all the settings are shown on the main window, the first and second operation patterns do not appear. As the erroneous operations concerning the fourth operation pattern may appear in any case, the detection standard may be modified. In addition, inefficient operation patterns may appear in many ways depending on the settings to be input, the operation reception methods, and the like, and are not limited to those shown in the above embodiment. There may be added other inefficient patterns.

In the above embodiment, the operational characteristics data on multiple image forming apparatuses 400 can be generated or output on the server device 100, but the present invention is not limited to this example. The process may be performed on the image forming apparatuses 400, or may be performed on computers respectively for the image forming apparatuses 400. Further, in the above embodiment, the process is performed by the program 121 on one computer, but the present invention is not limited to this example. The process may be divided to be performed on multiple computers, or the data processed on each of the multiple computers may be integrated in one server.

In the above embodiment, the operation log data is transmitted from the image forming apparatus 400 to the server device 100 under the control of the image forming apparatus 400 side. However, the operation log data may be regularly transmitted from the server device 100 to the image forming apparatus 400.

The image forming apparatus 400 is not limited to that of the electrophotographic type, and may be of the inkjet type or the like.

Though the computer-readable medium storing the program 121 concerning the acquisition control of the operational characteristics in the present invention is described above with the storage 120 that is a non-volatile memory such as an HDD and a flash memory as an example, the embodiments are not limited to that. For example, a portable storage medium such as a CD-ROM, DVD disk, etc. can be applied as the computer readable storage medium. A carrier wave is also applied as the medium to provide data of the program according to the embodiments through the communication lines.

The details of the configurations and procedures of processing shown in the embodiments can be suitably changed without leaving the scope of the present invention. The scope of the present invention encompasses the scope of the invention recited in the claims and the equivalent thereof.

What is claimed is:

1. An operational characteristics acquisition device comprising:
an acquirer that acquires an operation log of an image forming apparatus; and
an analyzer that analyzes the acquired operation log so as to generate operational characteristics data concerning appearance of an inefficient operation.

2. The operational characteristics acquisition device according to claim 1,
wherein the operation log includes a content of a user input operation on the image forming apparatus,
wherein the analyzer determines whether the user input operation is the inefficient operation based on an order and an interval of the user input operation.

3. The operational characteristics acquisition device according to claim 1, further comprising:
a storage that stores an operation pattern of the inefficient operation;
wherein the analyzer detects the operation log corresponding to the operation pattern.

4. The operational characteristics acquisition device according to claim 3,
wherein the storage stores the operation pattern, a cause or situation deduced from the inefficient operation corresponding to the operation pattern,
wherein the analyzer generates the operational characteristics data including the appearance of the inefficient operation associated with the deduced cause or situation.

5. The operational characteristics acquisition device according to claim 4,
wherein an operation setting of the image forming apparatus includes a setting set by an operation on one of multiple reception screens displayed by a selecting operation of a selection button shown on a display screen,
wherein the operation pattern includes a first operation pattern of opening and closing a reception screen concerning a final selection more than a predetermined number of times before the operation concerning the final selection,
wherein the storage stores information indicating that lack of a skill of finding a target on the operation screen is deduced from the first operation pattern.

6. The operational characteristics acquisition device according to claim 4,
wherein an operation setting of the image forming apparatus includes a setting set by an operation on one of multiple reception screens displayed by a selecting operation of a selection button shown on a display screen,
wherein the operation pattern includes a second operation pattern of opening and closing a reception screen not concerning a final selection more than a predetermined number of times before the operation concerning the final selection,
wherein the storage stores information indicating that lack of knowledge about the operation screen is deduced from the second operation pattern.

7. The operational characteristics acquisition device according to claim 4,
wherein the operation log includes a content of a user input operation on the image forming apparatus,
wherein reception of the user input operation is performed via a touch panel overlaid on the display screen,
wherein the operation pattern includes a third operation pattern of touching a predetermined surrounding area of a range of the reception of the user input operation concerning a final selection more than a predetermined number of times before an operation concerning the final selection,
wherein the storage stores information indicating that misalignment of a display position of the display screen and a user input reception range of the touch panel is deduced from the third operation pattern.

8. The operational characteristics acquisition device according to claim 4,
wherein the operation pattern includes a fourth operation pattern of closing a reception screen within a predetermined time since the reception screen is opened,
wherein the storage stores information indicating that an erroneous operation by a user is deduced from the fourth operation pattern.

9. The operational characteristics acquisition device according to claim 4,
wherein the operation pattern includes a fifth operation pattern of changing a predetermined setting parameter from an original value and then returning the setting parameter to the original value,
the storage stores information indicating that lack of understanding of the user of a function of the setting parameter is deduced from the fifth operation pattern.

10. The operational characteristics acquisition device according to claim 1,
wherein the analyzer calculates a first time during which a system setting of the image forming apparatus is performed and a second time during which a utility setting of the image forming apparatus is performed, and uses the first time and the second time as an index of an amount of an administrative operation.

11. The operational characteristics acquisition device according to claim 10,
wherein the operation log includes a content of a user input operation on the image forming apparatus,
wherein the analyzer defines, when a manual operation of handling a predetermined component is interposed within a reference time during the user input operation concerning the predetermined component, the sum of time spent on the manual operation and time spent on the user input operation as an operation time concerning the predetermined component.

12. the operational characteristics acquisition device according to claim 10,
wherein the operation log includes a content of a user input operation on the image forming apparatus,
wherein the analyzer defines, when a manual operation of handling a different component than a predetermined component is interposed within a reference time during the user input operation concerning the predetermined component, an operation time concerning the predetermined component excluding time spent on the manual operation of handling the different component.

13. An operational characteristics acquisition method, comprising:
acquiring an operation log of an image forming apparatus; and
analyzing the acquired operation log so as to generate an operational characteristics data concerning appearance of a predetermined inefficient operation.

14. A non-transitory computer-readable storage medium storing a program that causes a computer to perform:
acquisition of an operation log of an image forming apparatus; and
analysis of the acquired operation log so as to generate an operational characteristics data concerning appearance of a predetermined inefficient operation.
